(19) United States
(12) Patent Application Publication
(10) Pub. No.: US 2018/0344021 A1
(43) Pub. Date: Dec. 6, 2018

(54) BOTTLE OPENING BRUSH

(71) Applicant: The Cricket Company, LLC, Novato, CA (US)

(72) Inventor: Karen M. Delzell, Novato, CA (US)

(21) Appl. No.: 15/997,538

(22) Filed: Jun. 4, 2018

Related U.S. Application Data
(60) Provisional application No. 62/515,355, filed on Jun. 5, 2017.

(51) Int. Cl. A46B 15/00; A46B 5/02; B67B 7/16

(52) U.S. Cl. CPC A46B 15/0063; A46B 5/02; A46B 2200/405; A46B 2200/104; B67B 7/16

(57) ABSTRACT

A bottle opening brush and methods for using the same are provided. The bottle opening brush can include a body and a bottle opener. The body can include a brush head coupled to a handle. One or more bristles can be secured to the brush head and extend outwards therefrom. A handle opening can extend through the handle and the bottle opener can include an opener head. The bottle opener can be mounted to the body such that the opener head can engage a bottle cap inserted within the handle opening to remove a bottle cap from a bottle. The utility of the bottle opening brush for brushing hair can be unimpaired by the presence of the bottle opener.

### CROSS-REFERENCE TO RELATED APPLICATIONS

This application claims the benefit of priority of U.S. Provisional Patent Application No. 62/515,355, filed on Jun. 5, 2017, entitled “Bottle Brush,” the entirety of which is hereby incorporated by reference.

### BACKGROUND

Metal caps can be used to seal containers, such as beverage containers. As an example, a bottle cap can be placed over a top opening of a glass bottle and, by pressing the bottle cap over and around the bottle opening, it can engage a flange on the bottleneck to seal the bottle. While bottle caps can provide a robust seal to a bottle, they can be difficult to remove by hand.

### SUMMARY

Tools have been developed for removing bottle caps from bottles. In some cases, these tools are commonly designed for use in food and/or beverage preparation areas (e.g., kitchens, bars, etc.) and cannot be moved. As a result, such tools are unsuitable for circumstances where a user travels to locations other than food and/or beverage preparation areas. In other cases, when bottle opening tools are designed to be carried by a person, they can be easily misplaced or forgotten when traveling to locations that lack bottle opening tools.

Accordingly, there exists a continuing need for bottle opening tools that are portable, difficult to lose, and unlikely to be forgotten when traveling to locations that lack bottle opening tools.

In general, systems and methods are provided for removing a bottle cap from a bottle.

In one embodiment, a bottle opening brush is provided. The bottle opening brush can include a body extending between a proximal end and a distal end. The body can include a brush head coupled to a handle. The brush head can be positioned adjacent to the distal end of the body and the handle can extend from the brush head to the proximal end of the body. The bottle opening brush can also include one or more bristles secured to the brush head and extending outwards therefrom. The bottle opening brush can additionally include a handle opening extending through the handle and a bottle opener including an opener head. The bottle opener can be mounted to the body such that the opener head can engage a bottle cap inserted within the handle opening.

In another embodiment, the brush head can include at least one of a half-radial head, a round head, a paddle head, and a teasing head.

Embodiments of the brush head can have a variety of configurations. In one aspect, the brush head can include one or more vents extending through the brush head in a thickness direction. In another aspect, the brush head does not include vents extending through the brush head in a thickness direction.

In another embodiment, the handle can be dimensioned to be held by a human hand.

In another embodiment, the handle opening can be positioned adjacent to the proximal end of the body.

In another embodiment, the bottle opener can include an aperture formed in the opener head.

In another embodiment, the bottle opener can be positioned within the body such that at least a portion of the aperture is accessible through the handle opening.

In another embodiment, a shape of the aperture can be dimensioned to receive at least a portion of a bottle cap therein.

In another embodiment, the opener head can include one or more protrusions formed along an outer periphery of the aperture.

In another embodiment, the one or more protrusions can be arranged with respect to the aperture for engagement with a bottle cap received within the aperture.

In another embodiment, the one or more protrusions can extend within the handle opening.

In another embodiment, the bottle opener can include a shaft and the bottle opener can be mounted to the body such that the shaft extends along at least a portion of the length of the handle.

In another embodiment, the shaft can be configured to inhibit out of plane bending of the handle.

In another embodiment, the bottle opener can have an elastic modulus greater than or equal to that of an elastic modulus of the body.

In another embodiment, the shaft can extend from about the opener head to the brush head.

In another embodiment, the shaft can extend within the brush head.

In another embodiment, the shaft can include one or more engagement features allowing a portion of the body to extend within the shaft.

### DESCRIPTION OF THE DRAWINGS

These and other features will be more readily understood from the following detailed description taken in conjunction with the accompanying drawings, in which:

FIG. 1 is a perspective view illustrating one exemplary embodiment of a bottle opening brush including a hair brush and a bottle opener;

FIG. 2 is a front view illustrating the bottle opening brush of FIG. 1;

FIG. 3 is a rear view illustrating the bottle opening brush of FIG. 1;

FIG. 4 is a perspective view of the hair brush of FIG. 1;

FIG. 5 is a perspective view of the bottle opener of FIG. 1;

FIG. 6 is a transparent perspective view of the bottle opening brush of FIG. 1;

FIG. 7 is a front view of another exemplary embodiment of a bottle opening brush including a hair brush and a bottle opener; and

FIG. 8 is a rear view of the bottle opening brush of FIG. 7.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

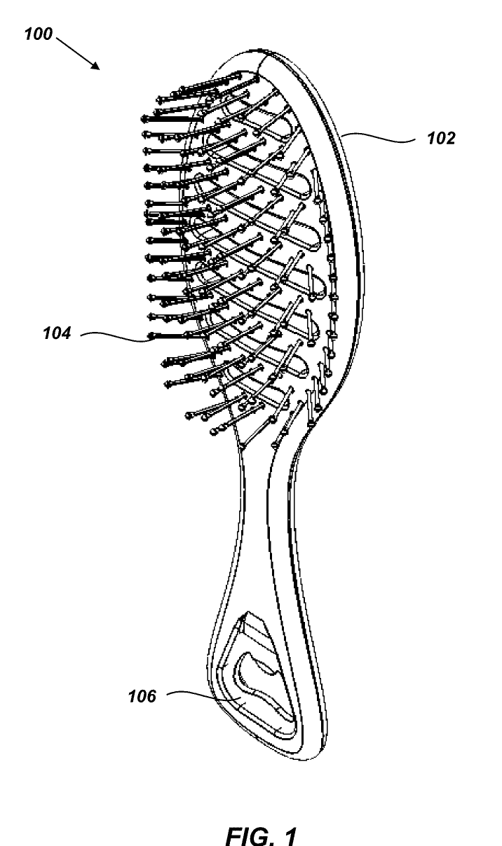

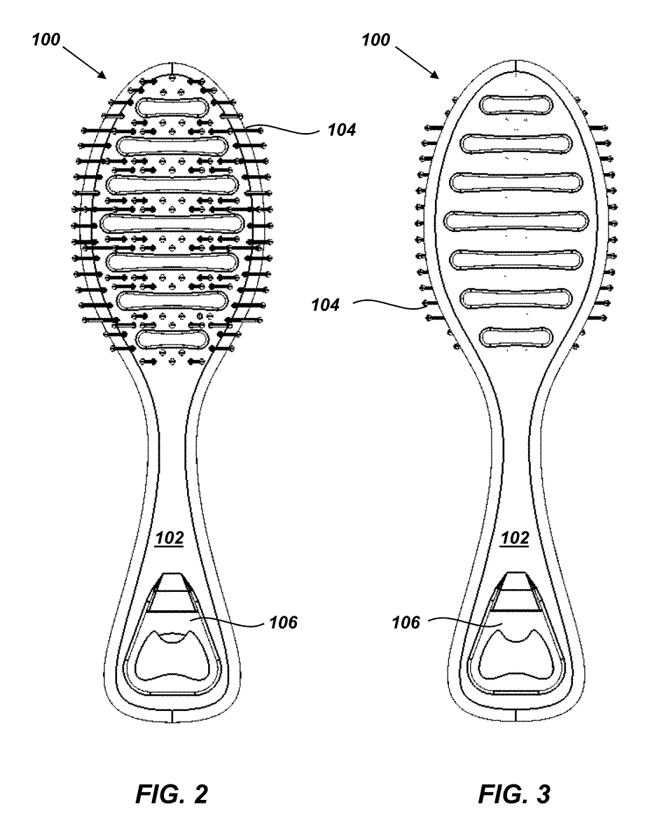

FIGS. 1-3 illustrate one exemplary embodiment of a bottle opening brush 100 including a hair brush 102 having bristles 104 and a bottle opener 106. Embodiments of the hair brush 102, the bristles 104, and the bottle opener 106 can be formed from any materials in any combination. Examples can include, but are not limited to, natural materials (e.g., bone, ivory, wood) and synthetic materials (e.g., polymers, ceramics, metals, metal alloys), and any combination thereof. As discussed in greater detail below, the bottle opener 106 can be mounted to the hair brush 102 (e.g., within at least a portion of the hair brush 102) such that the bottle opener 106 can be employed to remove a bottle cap from a bottle. So configured, embodiments of the bottle opening brush 100 can be portable, yet difficult to lose. Furthermore, the utility of the hair brush 102 for brushing hair can be unimpaired by the presence of the bottle opener 106. Because hair brushes are commonly carried to many locations where there is a need to open bottles (e.g., parks, beaches, pools, etc.), embodiments of the bottle opening brush 100 are unlikely to be left behind or forgotten when traveling.

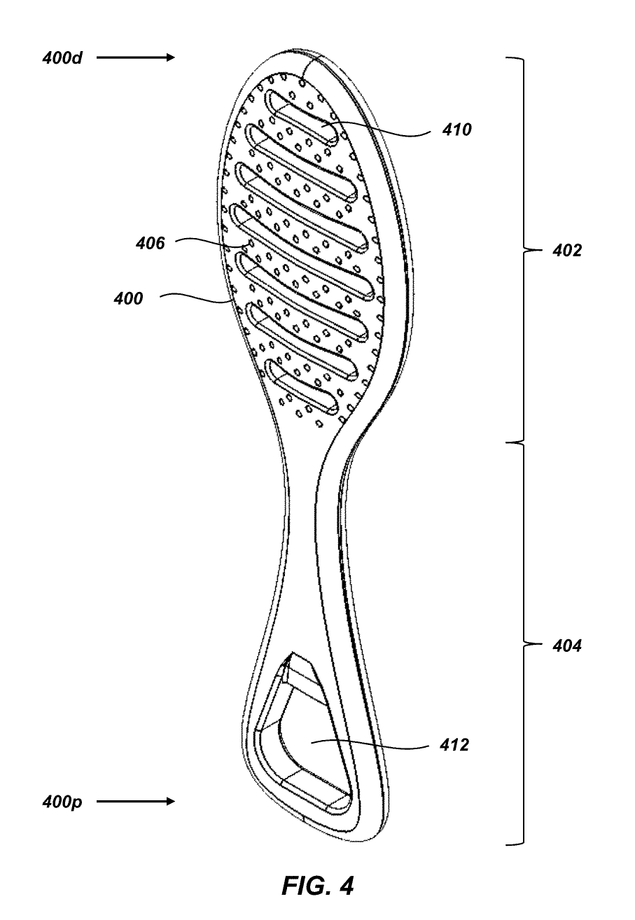

FIG. 4 illustrates one exemplary embodiment of the hair brush 102, omitting the bristles 104 for clarity. The hair brush 102 can include a body 400 extending between a proximal end 400p and a distal end 400d. The body 400 can include a brush head 402 coupled to a handle 404. The brush head 402 can be positioned at or adjacent to the distal end 400d and the handle 404 can extend from the brush head 402 to a position at or adjacent to the proximal end 400p. In certain embodiments, the handle can be integrally formed with the brush head (e.g., by molding or casting). In alternative embodiments, the handle and the brush head can be formed as separate components and secured to one another by one or more fastening mechanisms (e.g., by adhesives, frictional couplings, compressive couplings, threaded engagements, and any combination thereof).

Embodiments of the brush head 402 can adopt a variety of configurations. As shown, the brush head 402 can include sockets 406 for receipt of the bristles 104. Optionally, one or more vents 410 can also be formed through the thickness of the brush head 402 to facilitate airflow and hair drying. While the brush head 402 is illustrated with a half-radial configuration, a person skilled in the art will appreciate that embodiments of the brush head can adopt other shapes without limit including, but not limited to, round heads, paddle heads, and teasing heads.

The handle 404 can be elongated and dimensioned to be held by a human hand. The handle 404 can also include an opening 412. In certain embodiments, the handle opening 412 can be formed adjacent the proximal end 400p. As discussed in greater detail below, the handle 404 can be configured for receipt of the bottle opener 106.

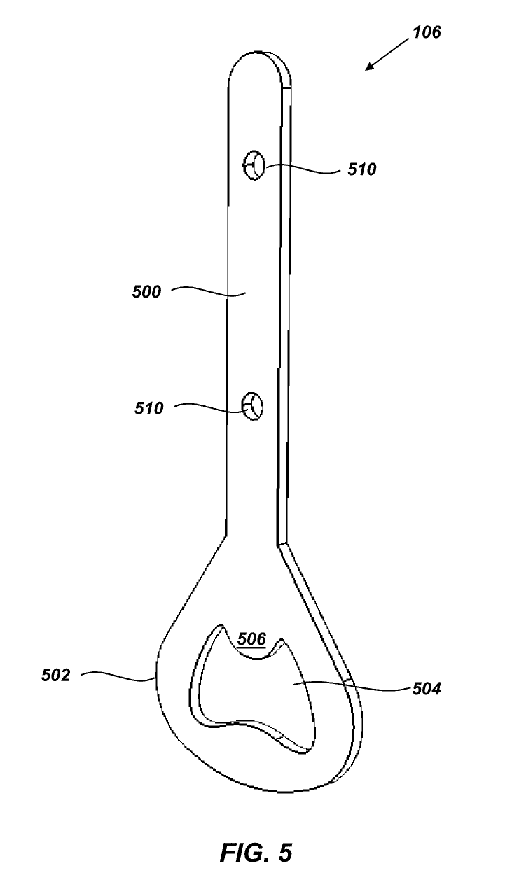

An exemplary embodiment of the bottle opener 106 is illustrated in FIG. 5. The bottle opener 106 can include an elongated shaft 500 and an opener head 502. The opener head 502 can include an aperture 504 formed therethrough. The shape of the aperture 504 can be dimensioned to receive at least a portion of a bottle cap therein. In certain embodiments, one or more protrusions 506 can be formed along an outer periphery of the aperture 504. The protrusions 506 can be further arranged with respect to the aperture 504 for engagement with a bottle cap received within the aperture 504. As an example, the protrusions 506 can extend within the aperture 504.

In alternative embodiments, the bottle opener can adopt shapes other than those illustrated in FIG. 5. In one aspect, the aperture can adopt shapes including, but not limited to, square, rectangular, round, and oval. In another aspect, the bottle opener can extend outwards from the plane of the handle and include one or more protrusions dimensioned to engage a bottle cap for removal.

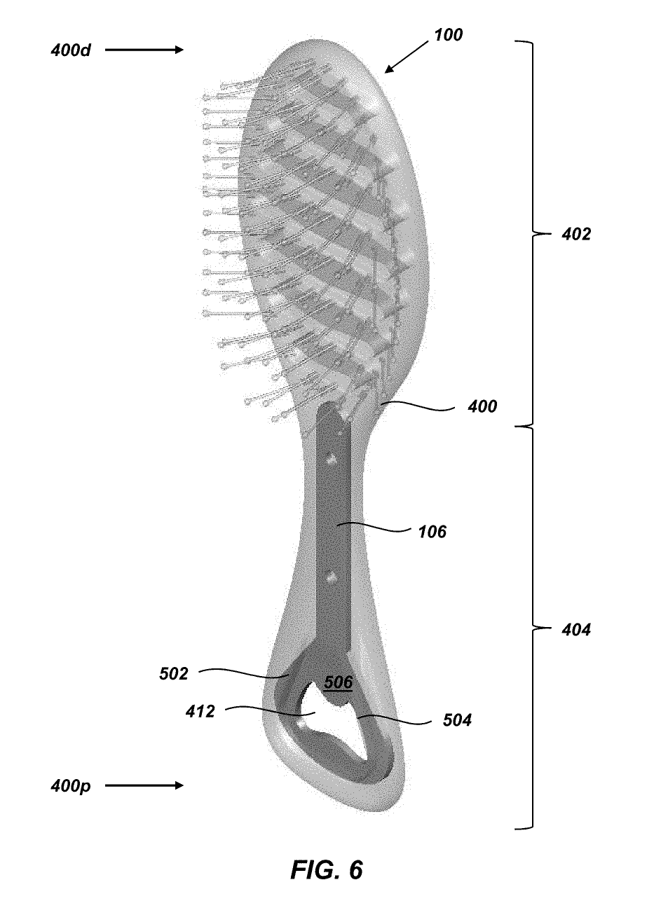

FIG. 6 shows the bottle opening brush 100 in a transparent perspective view and illustrates the bottle opener 106 mounted within the bottle opening brush 100. In certain embodiments, the bottle opener 106 can be mounted within the hair brush 102 by molding the body 400 about the bottle opener 106. In other embodiments, the body 400 can be formed in two or more pieces (e.g., halves) having an internal cavity (not shown) that is dimensioned to receive the bottle opener 106. The shaft 500 can include one or more engagement features 510 (e.g., holes), allowing a portion of the body 400 (e.g., the a portion of the handle 404) to extend within the shaft 500 to promote coupling of the bottle opener 106 within the body 400. It can be appreciated that, in alternative embodiments, this engagement can be reversed, where the engagement features extend from the shaft and into corresponding recesses formed within the body.

As shown, the bottle opener 106 can be mounted within the body 400 such that at least a portion of the aperture 504 can be positioned at about the handle opening 412. That is, at least a portion of the aperture can be accessible through the handle opening 412. So positioned, one or more of the protrusions 506 extending within the handle opening 412.

The shaft 500 can further extend along at least a portion of the length of the handle 404. As an example, the shaft 500 can extend from the opener head 502 to the brush head 402. In certain embodiments, a distal end of \the shaft 500 can extend within the brush head 402. In other embodiments (not shown), the distal end of the shaft can terminate within the handle.

The shaft 500 can be dimensioned (e.g., length, width, and/or thickness) such that the shaft 500 reinforces the handle 404. In further embodiments, the shaft 500 can be formed from a first material (e.g., a metal) having an elastic modulus greater than or equal to an elastic modulus of a second material (e.g., a plastic) forming the body 400. In this manner, the shaft 500 can inhibit out of plane deformation (e.g., bending out of the plane of the handle 404) and attendant mechanical damage to the bottle opening brush 100 (e.g., fracture due to critical and/or sub-critical crack growth) when used to open a bottle.

In use, a user can position a bottle cap sealed to a bottle within the handle opening 412. The protrusions 506 can also be positioned under a rim of the bottle cap. Subsequently, the user can manipulate the bottle opening brush 100 such that the protrusions 506 can apply a force to the bottle cap rim in a direction away from the bottle so as to force (e.g., pry) the bottle cap from the bottle. As an example, if the bottle is oriented approximately vertically, the protrusions 506 can be moved in an upwards direction to force the bottle cap from the bottle. As noted above, the shaft 500 can reinforce the body 400 and inhibit out of plane bending of the body 400 (e.g., the handle 404) when applying force to the bottle cap rim.

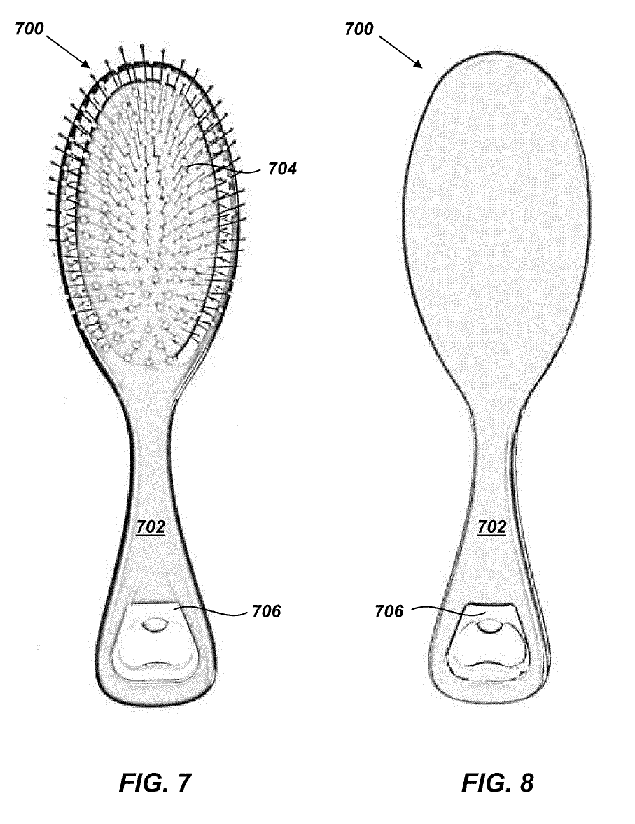

FIGS. 7-8 illustrate another exemplary embodiment of a bottle opening brush 700 including a hair brush 702 having bristles 704 and a bottle opener 706. The bristles 704 and bottle opener 706 can be the same as bristles 104 and bottle opener 106 of FIG. 1. The hair brush 702 can differ from hair brush 102 of FIG. 1 by omission of the vents 410.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

A person skilled in the art will appreciate further features and advantages of the invention based on the above-described embodiments. Accordingly, the invention is not to be limited by what has been particularly shown and described, except as indicated by the appended claims. All publications and references cited herein are expressly incorporated by reference in their entirety.

What is claimed is:

1. A bottle opening brush, comprising:
a body extending between a proximal end and a distal end and including a brush head coupled to a handle, wherein the brush head is positioned adjacent to the distal end of the body and the handle extends from the brush head to the proximal end of the body;
one or more bristles secured to the brush head and extending outwards therefrom;
a handle opening extending through the handle; and
a bottle opener including an opener head, wherein the bottle opener is mounted to the body such that the opener head can engage a bottle cap inserted within the handle opening.

2. The bottle opening brush of claim 1, wherein the brush head comprises at least one of a half-radial head, a round head, a paddle head, and a teasing head. bottle opening brush

3. The bottle opening brush of claim 1, further comprising one or more vents extending through the brush head in a thickness direction. bottle opening brush

4. The bottle opening brush of claim 1, wherein the brush head does not include vents extending through the brush head in a thickness direction.

5. The bottle opening brush of claim 1, wherein the handle is dimensioned to be held by a human hand.

6. The bottle opening brush of claim 1, wherein the handle opening is positioned adjacent to the proximal end of the body.

7. The bottle opening brush of claim 1, wherein the bottle opener further comprises an aperture formed through the opener head.

8. The bottle opening brush of claim 7, wherein the bottle opener is positioned within the body such that at least a portion of the aperture is accessible through the handle opening.

9. The bottle opening brush of claim 8, wherein a shape of the aperture is dimensioned to receive at least a portion of a bottle cap therein.

10. The bottle opening brush of claim 8, wherein the opener head comprises one or more protrusions formed along an outer periphery of the aperture.

11. The bottle opening brush of claim 10, wherein the one or more protrusions are arranged with respect to the aperture for engagement with a bottle cap received within the aperture.

12. The bottle opening brush of claim 10, wherein the one or more protrusions extend within the handle opening.

13. The bottle opening brush of claim 1, wherein the bottle opener further comprises a shaft and wherein the bottle opener is mounted to the body such that the shaft extends along at least a portion of the length of the handle.

14. The bottle opening brush of claim 13, wherein the shaft is configured to inhibit out of plane bending of the handle.

15. The bottle opening brush of claim 14, wherein the bottle opener has an elastic modulus greater than or equal to that of an elastic modulus of the body.

16. The bottle opening brush of claim 13, wherein the shaft extends from about the opener head to the brush head.

17. The bottle opening brush of claim 14, wherein the shaft extends within the brush head.

18. The bottle opening brush of claim 13, wherein the shaft comprises one or more engagement features allowing a portion of the body to extend within the shaft.
